(19) United States
(12) Patent Application Publication
(10) Pub. No.: US 2024/0233993 A9
(43) Pub. Date: Jul. 11, 2024

(54) SOFT MAGNETIC IRON ALLOY SHEET AND METHOD OF MANUFACTURING THE SAME

(71) Applicant: Hitachi, Ltd., Tokyo (JP)

(72) Inventors: Tomohiro TABATA, Tokyo (JP); Matahiro KOMURO, Tokyo (JP); Yusuke ASARI, Tokyo (JP); Shinya TAMURA, Tokyo (JP); Shohei TERADA, Tokyo (JP)

(21) Appl. No.: 18/278,477

(22) PCT Filed: Sep. 28, 2021
(86) PCT No.: PCT/JP2021/035519

§ 371 Date: Aug. 23, 2023

(30) Foreign Application Priority Data
Mar. 15, 2021 (JP) 2021-041372

(51) Int. Cl. H01F 1/16; C21D 9/46; C22C 38/00; C22C 38/10; C22C 38/12

(52) U.S. Cl. CPC H01F 1/16; C21D 9/46; C22C 38/001; C22C 38/10; C22C 38/12; C21D 2211/005; C22C 2202/02

(57) ABSTRACT

A soft magnetic iron alloy sheet has a saturation magnetic flux density comparable to that of Permendur, with the same iron loss as electromagnetic pure iron, and a lower cost than Permendur. The soft magnetic iron alloy sheet includes, as a chemical composition, 30 at % or less of Co, 0.1 at % or more and 11 at % or less of N, and 1.2 at % or less of vanadium, with the remainder being Fe and impurities. In a thickness direction of the soft magnetic iron alloy sheet, a surface layer region has an average nitrogen concentration of 1 at % or more and 15 at % or less and an internal region has a lower average nitrogen concentration than the surface layer region. In the surface layer region, a thickness is 1% or more and 30% or less from both main surfaces of the sheet and iron-nitride martensite having a tetragonal structure is formed.

### TECHNICAL FIELD

The present invention relates to a technique of a magnetic material and particularly relates to a soft magnetic iron alloy sheet having a higher saturation magnetic flux density than an electromagnetic pure iron sheet and a method of manufacturing the same.

### BACKGROUND ART

An electromagnetic steel sheet or an electromagnetic pure iron sheet (for example, thickness: 0.01 to 1 mm) is a material that is used as an iron core of a rotating electric machine or a transformer by laminating a plurality of the sheets. In the iron core, it is important to increase the conversion efficiency between electric energy and magnetic energy, and high magnetic flux density and low iron loss are important. To increase the magnetic flux density, a saturation magnetic flux density Bs of a material is desirably high. As an iron-based material having high Bs, a Fe—Co-based alloy material or an iron-nitride martensite material is known.

A reduction in the cost of the iron core is, of course, one of the most important issues, and a technique of manufacturing the material having high Bs stably and inexpensively has been actively developed in the related art.

For example, PTL 1 (JP2020-132894A) discloses a sheet-shaped or a foil-shaped soft magnetic material having a high saturation magnetic flux density, the soft magnetic material including iron, carbon, nitrogen, a martensite including carbon and nitrogen, and γ-Fe, in which a phase including nitrogen is formed in the γ-Fe.

PTL 1 describes that a soft magnetic material having a higher saturation magnetic flux density than pure iron and thermal stability can be manufactured at a low cost, and that properties of a magnetic circuit of an electric motor or the like can be improved using the soft magnetic material such that miniaturization, high torque, and the like of the electric motor or the like can be implemented.

### CITATION LIST

### Patent Literature

PTL 1: JP2020-132894A

### SUMMARY OF INVENTION

### Technical Problem

Among currently commercially available soft magnetic materials, Permendur (49Fe-49Co-2V mass %=50Fe-48Co-2V at %) is well known as a material having the highest Bs. Note that the material cost of Co varies depending on market conditions but is 100 to 200 times higher than the material cost of Fe. Therefore, a weak point it is that Permendur is a material that requires an extremely high cost. In other words, in the Fe—Co-based alloy material, when the Co content decreases, the material cost can be decreased correspondingly.

However, the Fe—Co-based alloy material has a weak point in that, when the Co content decreases, Bs also decreases. A method of compensating for a decrease in Bs corresponding to a decrease in Co content using the formation of iron-nitride martensite can be considered. However, in the Fe—Co-based alloy material, it is known that nitrogen atoms are not likely to penetrate and diffuse, and it is difficult to form iron-nitride martensite. Therefore, a method of forming iron-nitride martensite in the Fe—Co-based alloy material is not established.

To form iron-nitride martensite, when an element (for example, Al, Cr, Mo, or Nb) for promoting penetration and diffusion of nitrogen atoms is added to the Fe—Co-based alloy material, there is another problem in that Bs further decreases and iron loss Pi increases.

On the other hand, in an iron core for a rotating electric machine (for example, a motor or a power generator) not only high Bs and low Pi but also a mechanical strength (for example, tensile strength) that endures a rotating centrifugal force are also important requirements.

Recently, a compact high-powered rotating electric machine is strongly required, and improvement of properties of the iron core is an urgent issue. As described above, a reduction in the cost of the iron core is one of the most important issues.

Accordingly, an object of the present invention is to provide a soft magnetic iron alloy sheet having a saturation magnetic flux density comparable to that of Permendur, having the same iron loss as electromagnetic pure iron, and having a lower cost than Permendur, and a method of manufacturing the soft magnetic iron alloy sheet.

### Solution to Problem

(I) According to one aspect of the present invention there is provided a soft magnetic iron alloy sheet including, as a chemical composition,
0 at % or more and 30 at % or less of cobalt (Co), 0.1 at % or more and 11 at % or less of nitrogen (N), 0 at % or more and 1.2 at % or less of vanadium (V), and a remainder consisting of iron (Fe) and impurities, in which
in a thickness direction of the soft magnetic iron alloy sheet, a surface layer region having an average nitrogen concentration of 1 at % or more and 15 at % or less and an internal region having a lower average nitrogen concentration than the surface layer region are provided, and
in the surface layer region, a thickness is 1% or more and 30% or less from both main surfaces of the soft magnetic iron alloy sheet, and iron-nitride martensite having a tetragonal structure is formed.

In the present invention, the surface layer region is defined as a region of an outermost layer including a main surface in a thickness direction of an iron sheet, and the internal region is defined as a region interposed between the surface layer regions.

In the present invention, in the above-described soft magnetic iron alloy sheet (I) according to the present invention, the following improvements or changes can be made.
(i) The average nitrogen concentration of the surface layer region is higher than the average nitrogen concentration of the internal region by 0.5 at % or more.
(ii) In the internal region, ferrite having a cubic structure is a primary phase.
(iii) The average nitrogen concentration of the internal region is less than 1 at %.
(iv) A saturation magnetic flux density is 2.2 T or more, and an iron loss under conditions of a magnetic flux density of 1.0 T and 400 Hz is less than 50 W/kg.
(II) According to another aspect of the present invention there is provided a method of manufacturing the above-described soft magnetic iron alloy sheet, the method comprising:
a starting material preparation step of preparing a starting material having a thickness of 0.01 mm or more and 1 mm or less that is formed of a soft magnetic material including Fe as a main component and including 0 at % or more and 30 at % or less of Co;
a nitrogen penetration heat treatment step of heating and quenching the starting material in a predetermined ammonia (NH₃) gas atmosphere to cause 1 at % or more and 15 at % or less of N to penetrate and diffuse into a surface layer region of the starting material; and
a subzero treatment step of cooling the starting material having undergone the nitrogen penetration heat treatment step to 0° C. or lower, in which
the nitrogen penetration heat treatment step includes a nitrogen penetration process of heating the starting material while controlling a nitriding potential to a predetermined range in an atmosphere, and a cooling process of rapidly cooling the starting material to lower than 100° C. at a cooling rate of 100° C./s or faster at a cooling rate while controlling the nitriding potential to a predetermined range in an atmosphere.

In the present invention, in the above-described method of manufacturing the soft magnetic iron alloy sheet (II) according to the present invention, the following improvements or changes can be made.
(v) The nitriding potential K_{N} is defined as “K_{N}=P_{NH3}/P_{H2}^{3/2}” from an NH₃ gas partial pressure P_{NH3} and a H₂ gas partial pressure P_{H2} in the NH₃ gas atmosphere, and is controlled to satisfy “0.001 atm^{-1/2}≤K_{N}≤10 atm^{-1/2}”.

### Advantageous Effects of Invention

According to the present invention, it is possible to provide a soft magnetic iron alloy sheet having a saturation magnetic flux density comparable to that of Permendur, having the same iron loss as electromagnetic pure iron, and having a lower cost than Permendur and a method of manufacturing the soft magnetic iron alloy sheet.

### BRIEF DESCRIPTION OF DRAWINGS

FIG. 1 is a process diagram illustrating an example of a method of manufacturing a soft magnetic iron alloy sheet according to the present invention.

FIG. 2A is a diagram illustrating a result of N concentration quantitative analysis in a sheet thickness direction with respect to a cross-section of Example 1 and an X-ray diffraction pattern with respect to a surface of Example 1.

FIG. 2B is a diagram illustrating a result of N concentration quantitative analysis in a sheet thickness direction on a cross-section of Comparative Example 1 and an X-ray diffraction pattern of a surface of Comparative Example 1.

FIG. 2C is a diagram illustrating a result of N concentration quantitative analysis in a sheet thickness direction on a cross-section of Comparative Example 2 and an X-ray diffraction pattern of a surface of Comparative Example 2.

FIG. 3 is a diagram illustrating a result of N concentration quantitative analysis in a sheet thickness direction on a cross-section of Example 2 and an X-ray diffraction pattern of a surface of Example 2.

FIG. 4 is a diagram illustrating a result of N concentration quantitative analysis in a sheet thickness direction on a cross-section of Comparative Example 3.

### DESCRIPTION OF EMBODIMENTS

The present inventors conducted a thorough investigation on a method of causing nitrogen atoms to penetrate and diffuse into a Fe—Co-based alloy sheet to form iron-nitride martensite. As a result, it was found that, by adjusting a Co content to be 30 at % or less, controlling a nitriding potential to a predetermined range during a nitrogen penetration heat treatment, and controlling a cooling rate during cooling, iron-nitride martensite is effectively formed on a surface layer region of the Fe—Co-based alloy sheet. It is verified that, the obtained Fe—Co-based alloy sheet has a saturation magnetic flux density comparable to that of Permendur and has the same iron loss as electromagnetic pure iron, regardless of a decrease in Co content. The present invention has been completed based on the finding.

Hereinafter, an embodiment of the present invention will be described in detail according to a manufacturing procedure with reference to the drawings. Note that the present invention is not limited to the embodiment described herein and can be appropriately combined with a well-known technique or can be improved based on a well-known technique within a range not departing from the technical idea of the present invention. In the present specification, a case where a Fe—Co alloy sheet is used as a starting material will be described in detail. However, even when a Fe foil not including Co is used as a starting material, by making a difference in average nitrogen concentration between a surface layer region and an internal region, high saturation magnetic flux density and low iron loss can be simultaneously achieved.

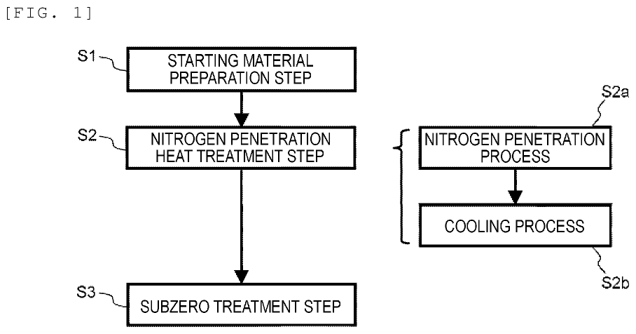

FIG. 1 is a process diagram illustrating an example of a method of manufacturing a soft magnetic iron alloy sheet according to the present invention. As illustrated in FIG. 1, the method of manufacturing the soft magnetic iron alloy sheet according to the present invention schematically includes a starting material preparation step S1, a nitrogen penetration heat treatment step S2, and a subzero treatment step S3. The nitrogen penetration heat treatment step S2 includes a nitrogen penetration process S2a and a cooling process S2b. Hereinafter, each of the steps will be described in more detail.

In the starting material preparation step S1, a sheet material (thickness: 0.01 to 1 mm) including Fe as a main component (a component having highest content) and 0 at % or more and 30 at % or less of Co is prepared. By adjusting the Co content to be 30 at % or less, penetration and diffusion of N can be performed, and the material cost can be significantly reduced as compared to Permendur. The Co content is preferably 3 at % or more and 30 at % or less, more preferably 5 at % or more and 25 at % or less, and still more preferably 8 at % or more and 20 at % or less.

Although it is not an essential component, V may be included in an amount that is less than 4% of the Co content (for example, when Co=30 at %, V 1.2 at %. The means of the starting material preparation step S1 is not particularly limited, and a well-known method can be appropriately used. A commercially available product may be used.

Impurities (impurities that may be included in the starting material, for example, hydrogen (H), boron (B), carbon (C), silicon (Si), phosphorus (P), sulfur (S), chromium (Cr), manganese (Mn), nickel (Ni), or copper (Cu)) are allowed within a range (for example, total concentration less than 2 at %) where there are no adverse effects on the Bs of the soft magnetic iron alloy sheet.

Next, in the nitrogen penetration heat treatment step S2, a nitrogen penetration heat treatment of causing N to penetrate into a surface layer region of the sheet material of the prepared starting material is performed. The nitrogen penetration heat treatment according to the present invention includes: the nitrogen penetration process S2a of heating the starting material while controlling a nitriding potential to a predetermined range; and the cooling process S2b of controlling a cooling rate while controlling the nitriding potential to a predetermined range. The manufacturing method according to the present invention has the most distinctive characteristic in the nitrogen penetration heat treatment step S2.

In the nitrogen penetration process S2a, nitrogen is caused to penetrate and diffuse up to a desired N concentration in an environment of a temperature of 500° C. or higher (for example, austenite (γ phase) formation temperature range) and a predetermined ammonia gas atmosphere. As the ammonia gas atmosphere, mixed gas of NH₃ gas and N₂ gas, mixed gas of NH₃ gas and Ar gas, or mixed gas of NH₃ gas and H₂ gas can be suitably used.

The nitriding potential in the nitrogen penetration heat treatment step S2 is controlled to a predetermined range. The nitriding potential KN is defined as “K_{N}=P_{NH3}/P_{H2}^{3/2}” from an ammonia gas partial pressure P_{NH3} and a hydrogen gas partial pressure P_{H2} in the heat treatment, and a NH₃ gas flow rate, a carrier gas (N₂ gas, Ar gas, H₂ gas) flow rate, a total pressure in the heat treatment furnace are controlled to satisfy “0.001 atm^{-1/2}≤K_{N}≤10 atm^{-1/2}”, The total pressure in the heat treatment furnace is preferably 0.4 atm or higher.

It is preferable to introduce NH₃ gas after the temperature reaches 500° C. or higher. The reason is that, when NH₃ gas is actively introduced (K_{N} is increased) in a stable temperature range of ferrite (α phase), undesired iron nitride phase (for example, Fe₄N phase (γ′ phase) or Fe₃N phase (s phase)) is more likely to be formed than desired iron nitride phase having a tetragonal structure (Fe₈N phase (α′ phase) and/or Fe₁₆N₂ phase (α″ phase).

By controlling the temperature, the time, and K_{N} in the nitrogen penetration process S2a, the thickness and the N concentration in the surface layer region (high N concentration layer) where nitrogen penetrates and diffuses can be controlled. The entire soft magnetic iron alloy sheet includes 0.1 at % or more and 11 at % or less of nitrogen. An average N concentration of the surface layer region as the high N concentration layer is preferably 1 at % or more and 15 at % or less and more preferably 2 at % or more and 11 at % or less.

It is preferable that the thickness of the surface layer region (high N concentration layer) is controlled to be 1% or more and 30% or less from each of both main surfaces of the sheet material. In other words, it is preferable that the internal region of the sheet material is a low N concentration layer (average N concentration <1 at %) where nitrogen is not likely to penetrate and diffuse, and it is more preferable that the average N concentration is 0.5 at % or less.

In iron-nitride martensite (α′ phase and/or α″ phase) having a tetragonal structure formed in the subsequent cooling process S2b, strain in a crystal lattice caused by penetration of nitrogen atoms contributes to improvement of Bs. On the other hand, α′ phase and α″ phase also have a weak point in that Pi is likely to increase due to an increase in magnetic crystalline anisotropy. On the other hand, in the iron alloy sheet according to the present invention, the internal region is ferrite (α phase) having a low N concentration such that an increase in Pi can be prevented in the total iron alloy sheet.

It is preferable that a part of the surface layer region (high N concentration layer) forms a nitrogen concentration transition region (an average concentration gradient is 0.1 at %/μm or more and 10 at %/μm or less) where the N concentration decreases toward the internal region (low N concentration layer). By forming the N concentration gradient, a magnetization state (a magnetic domain or magnetization) in the α′ phase and/or the α″ phase having a high N concentration is likely to propagate to the α phase having a low N concentration. As a result, the coercive force as a whole decreases, which contributes to a reduction in Pi.

After causing nitrogen to penetrate and diffuse up to a desired N concentration in the nitrogen penetration process S2a, the cooling process S2b of rapidly cooling the starting material to lower than 100° C. is performed while maintaining K_{N}. Here, a cooling rate is preferably 100° C./s or faster, more preferably 200° C./s or faster, and still more preferably 400° C./s or faster. As a result, desired iron-nitride martensite having a tetragonal structure is formed. When the cooling rate is slower than 100° C./s, undesired iron nitride phase is likely to be formed.

When the cooling process S2b is performed while K_{N} is not maintained, a denitrification phenomenon in which nitrogen penetrated into the surface layer region is taken out occurs, and it is difficult to form the iron nitride phase itself.

Due to the cooling process S2b, most of the austenite (γ phase) can be transformed into martensite structure, but a part of γ phase may remain (residual γ phase). Since the γ phase is nonmagnetic, it is preferable that a volume fraction of the residual γ phase is 5% or less from the viewpoint of magnetic characteristics.

To transform the residual γ phase into martensite structure, it is preferable to perform the subzero treatment step S3 (for example, a normal subzero treatment using dry ice, or a super subzero treatment using liquid nitrogen) of cooling the starting material to 0° C. or lower after the cooling process S2b.

Although it is not an essential step, to impart toughness to the soft magnetic iron alloy sheet, a tempering step S4 (not illustrated in FIG. 1) may be performed at 100° C. or higher and 210° C. or lower after the subzero treatment step S3.

As described above, by quenching the sheet material including Fe as a main component and 0 at % or more and 30 at % or less of Co after penetration and diffusion of nitrogen into only the surface layer region, a complex is obtained in which the surface layer region is a phase having high Bs and high mechanical strength and the internal region is a phase having low magnetic crystalline anisotropy. As a result, the soft magnetic iron alloy sheet according to the present invention exhibits high Bs, low Pi, and high mechanical strength.

### EXAMPLES

Hereinafter, the present invention will be described in more detail using various experiments. Note that the present invention is not limited configurations and structures described in the experiments.

### Experiment 1

### (Preparation of Starting Material 1)

Commercially available pure metal raw materials (Fe and Co, purity thereof=99.9%) were mixed to prepare an alloy ingot on a water cooling copper hearth using an arc melting method (manufactured by Diavac Ltd., an automatic arc melting furnace, a reduced pressure AR atmosphere). Here, to homogenize the alloy ingot, the alloy ingot was remelted six times while inverting the sample. The obtained alloy ingot was pressed and rolled to prepare an 80 at % Fe-20 at % Co alloy sheet (thickness: =0.07 to 0.09 mm) as a starting material 1.

### Experiment 2

### (Preparation of Soft Magnetic Iron Alloy Sheets According to Example 1 and Comparative Examples 1 and 2)

Three kinds of nitrogen penetration heat treatments having different cooling processes were performed on sample materials of the starting material 1 prepared in Experiment 1. A nitrogen penetration process was performed under conditions where, after introducing NH₃ gas at a stage where the temperature reached 500° C., the sample was held at 500° C. for 2 hours and subsequently was held at 900° C. for 1 hour in a NH₃ gas atmosphere where the total pressure=0.8 atm and the nitriding potential ≈4 atm^{-1/2}.

Cooling process 1: after the nitrogen penetration process, water rapid cooling/water quenching was performed in which the test piece was immersed into water at room temperature (20° C.) while maintaining the NH₃ gas atmosphere (total pressure=0.8 atm, nitriding potential ≈4 atm^{-1/2}) was performed (average cooling rate ≈400° C./s). Next, a super subzero treatment was performed in which, after replacing the NH₃ gas atmosphere with a N₂ gas atmosphere, the sample material was immersed in liquid nitrogen within 5 minutes from the start of rapid cooling (the start of the cooling process). As a result, the residual γ phase was transformed into martensite structure. The corresponding sample was obtained as the soft magnetic iron alloy sheet according to Example 1.

Cooling process 2: water rapid cooling/water quenching in which, after replacing the NH₃ gas atmosphere with a N₂ gas atmosphere at a state of 900° C., the test piece was immersed in water at room temperature (20° C.) was performed (average cooling rate ≈400° C./s). Next, a super subzero treatment was performed in which, while maintaining the N₂ gas atmosphere, the sample material was immersed in liquid nitrogen within 5 minutes from the start of rapid cooling (the start of the cooling process). As a result, the residual γ phase was transformed into martensite structure. The cooling process 2 is different from the cooling process 1 in the atmosphere during cooling. The corresponding sample was obtained as the soft magnetic iron alloy sheet according to Comparative Example 1.

Cooling process 3: gas rapid cooling/gas quenching in which, after holding the test piece at 900° C. for 1 hour in the nitrogen penetration process, the test piece was sprayed with N₂ gas at room temperature (20° C.) was performed (average cooling rate ≈80° C./s). Next, a super subzero treatment was performed in which, while maintaining the N₂ gas atmosphere, the sample material was immersed in liquid nitrogen within 5 minutes from the start of rapid cooling (the start of the cooling process). As a result, the residual γ phase was transformed into martensite structure. The cooling process 3 is different from the cooling process 1 in the cooling rate. The corresponding sample was obtained as the soft magnetic iron alloy sheet according to Comparative Example 2.

### Experiment 3

### (Configuration Inspection of Soft Magnetic Iron Alloy Sheets According to Example 1 and Comparative Examples 1 and 2)

Using an electron probe micro analyzer (manufactured by JEOL Ltd., JXA-8800RL, spot diameter: 2 μm), N concentration quantitative analysis in a sheet thickness direction was performed on cross-sections of the samples (Example 1 and Comparative Examples 1 and 2) of the soft magnetic iron alloy sheets prepared in Experiment 2.

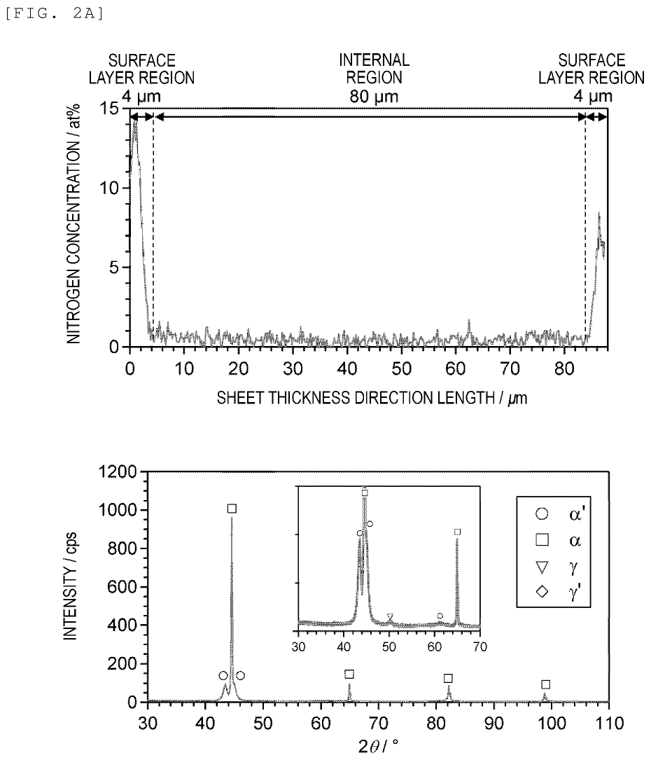

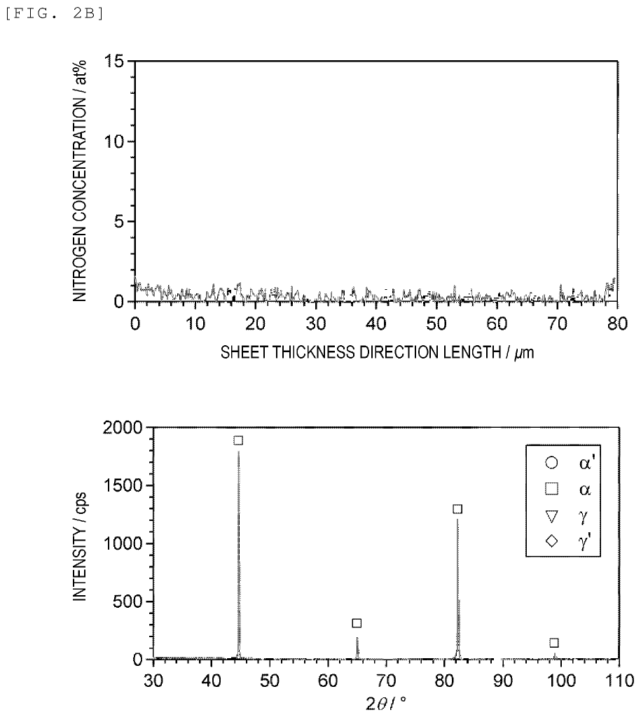

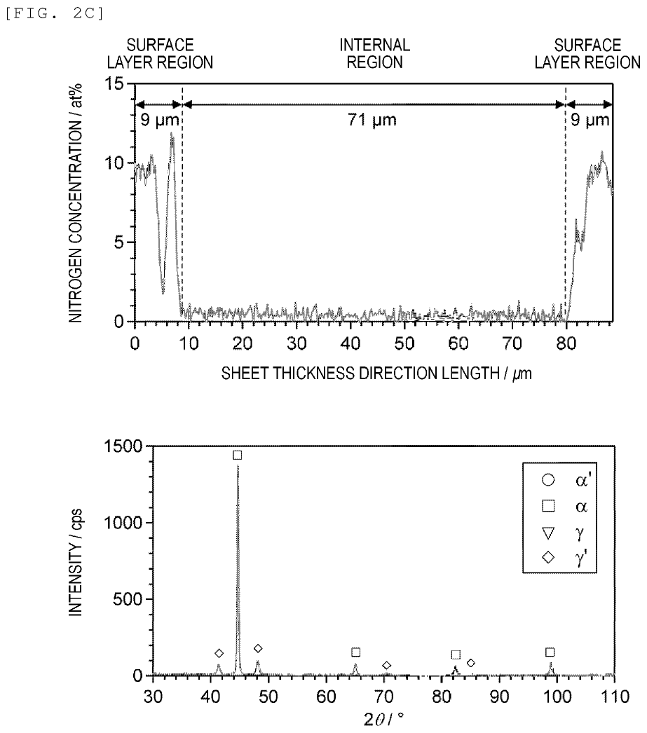

By performing wide angle X-ray diffraction (WAXD) using Cu-Kα rays on surfaces of the samples (Example 1 and Comparative Examples 1 and 2) of the soft magnetic iron alloy sheets, detected phases were identified. As the X-ray diffractometer, Rint-Ultima III (manufactured by Rigaku Corporation) was used. The results are illustrated in FIGS. 2A to 2C.

FIG. 2A is a diagram illustrating a result of the N concentration quantitative analysis in the sheet thickness direction on the cross-section of Example 1 and an X-ray diffraction pattern of the surface of Example 1.

As illustrated in FIG. 2A, it is verified from the N concentration quantitative analysis in the sheet thickness direction that, in Example 1, the high N concentration layer is formed in the surface layer region, the low N concentration layer is present in the internal region, and the N concentration transition region is formed in a part of the surface layer region. The formation of α phase (ferrite) as a primary phase and α′ phase (iron-nitride martensite having a tetragonal structure) are verified from the XRD pattern of the surface.

γ phase (austenite) and γ′ phase (Fe₄N phase) were not substantially detected.

Based on the above results, it is considered that the high N concentration layer is formed in the surface layer region through the nitrogen penetration process, the α′ phase is formed through the cooling process, and the residual γ phase does not substantially remain through the subzero treatment. In the XRD pattern, the α phase is a primary phase. Therefore, it is considered that the high N concentration layer of the surface layer region is a mixed phase state of α phase and α′ phase without being α′ phase as a whole.

FIG. 2B is a diagram illustrating a result of the N concentration quantitative analysis in the sheet thickness direction on the cross-section of Comparative Example 1 and an X-ray diffraction pattern of the surface of Comparative Example 1.

As illustrated in FIG. 2B, it is verified from the N concentration quantitative analysis in the sheet thickness direction that, in Comparative Example 1, the high N concentration layer is not formed in the surface layer region and the low N concentration layer is formed in the entire region in the sheet thickness direction. Only the α phase is verified from the XRD pattern of the surface.

Based on the above results, it is verified that, when the atmosphere in the cooling process deviates from the conditions of the present invention, the denitrification phenomenon occurs such that the high N concentration layer of the surface layer region cannot be maintained.

FIG. 2C is a diagram illustrating a result of the N concentration quantitative analysis in the sheet thickness direction on the cross-section of Comparative Example 2 and an X-ray diffraction pattern of the surface of Comparative Example 2.

As illustrated in FIG. 2C, it is verified from the N concentration quantitative analysis in the sheet thickness direction that, in Comparative Example 2, as in Example 1, the high N concentration layer is formed in the surface layer region, the low N concentration layer is present in the internal region, and the N concentration transition region is formed in a part of the surface layer region. However, from the XRD pattern of the surface, peaks of a phase and γ′ phase (Fe₄N phase) are verified, and a peak of α′ phase are not detected.

Based on the above results, it is considered that, when the cooling rate in the cooling process deviates from the conditions of the present invention, the formation of α′ phase by martensitic transformation does not occur, and γ′ phase closer to a thermal equilibrium state is formed.

### Experiment 4

### (Preparation of Soft Magnetic Iron Alloy Sheet According to Example 2)

A nitrogen penetration heat treatment different from that of Experiment 2 was performed on the sample material of the starting material 1 prepared in Experiment 1. A nitrogen penetration process was performed under conditions where, after introducing NH₃ gas at a stage where the temperature reached 1000° C., the sample was held at 1000° C. for 2 hours in a NH₃ gas atmosphere where the total pressure=0.8 atm and the nitriding potential ≈4.3 atm^{-1/2}. The cooling process was the same as the cooling process 1 of Experiment 2, except that, in the NH₃ gas atmosphere, the total pressure=0.8 atm and the nitriding potential ≈4.3 atm^{-1/2}. The corresponding sample was obtained as the soft magnetic iron alloy sheet according to Example 2.

(Configuration Inspection of Soft Magnetic Iron Alloy Sheet According to Example 2)

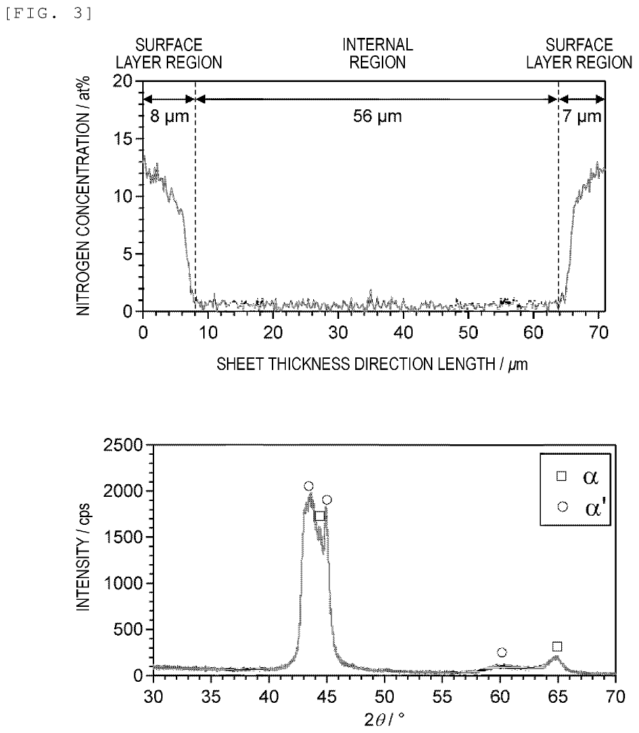

By performing N concentration quantitative analysis in a sheet thickness direction on a cross-section of Example 2 using EPMA as in Experiment 3, detected phases on a surface of Example 2 were identified by XRD. The results are illustrated in FIG. 3.

FIG. 3 is a diagram illustrating a result of the N concentration quantitative analysis in the sheet thickness direction on the cross-section of Example 2 and an X-ray diffraction pattern of the surface of Example 2.

As illustrated in FIG. 3, it is verified that, in Example 2, as in Example 1, the high N concentration layer is formed in the surface layer region, the low N concentration layer is present in the internal region, and the N concentration transition region is formed in a part of the surface layer region. The formation of α phase as a primary phase and α′ phase is verified from the XRD pattern of the surface.

It is verified from the results of Experiments 2 to 4 that, in the method of manufacturing the soft magnetic iron alloy sheet according to the present invention, the nitrogen penetration process S2a (the process of heating the starting material while controlling a nitriding potential to a predetermined range) and the cooling process S2b (the process of controlling a cooling rate while controlling the nitriding potential to a predetermined range) in the nitrogen penetration heat treatment step S2 are key points.

### Experiment 5

### (Preparation of Soft Magnetic Iron Alloy Sheet According to Comparative Example 3)

A commercially available electromagnetic pure iron sheet (thickness: 0.1 mm) was prepared. In the nitrogen penetration heat treatment, a nitrogen penetration process was performed under conditions where, after introducing NH₃ gas at a stage where the temperature reached 750° C., the sample was held at 750° C. for 5 hours in a NH₃ gas atmosphere where the total pressure=1 atm, the NH₃ partial pressure P_{NH3}=1×10⁴ Pa, and the N₂ partial pressure P_{N2}=2×10⁴ Pa.

In the cooling process, oil quenching in which, while maintaining the same NH₃ gas atmosphere, the test piece was immersed in oil at 60° C. was performed. Next, a super subzero treatment was performed in which, after replacing the NH₃ gas atmosphere with a N₂ gas atmosphere, the sample material was immersed in liquid nitrogen within 5 minutes from the start of rapid cooling (the start of the cooling process). As a result, the residual γ phase was transformed into martensite structure. The corresponding sample was obtained as the soft magnetic iron alloy sheet according to Comparative Example 3.

(Configuration Inspection of Soft Magnetic Iron Alloy Sheet According to Comparative Example 3)

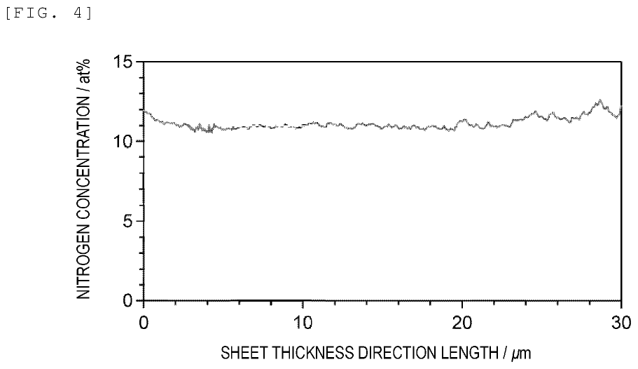

N concentration quantitative analysis in a sheet thickness direction was performed on a cross-section of Comparative Example 3 using EPMA as in Experiment 3. The results are illustrated in FIG. 4.

FIG. 4 is a diagram illustrating a result of N concentration quantitative analysis in a sheet thickness direction on a cross-section of Comparative Example 3. It is verified that, in Comparative Example 3, the high N concentration layer is uniformly formed in the sheet thickness direction and the low N concentration layer or the N concentration transition layer are not present. The reason is presumed to be that, in Comparative Example 3, a Co component as an inhibiting factor of penetration and diffusion of N was not present.

### Experiment 6

(Characteristic Inspection of Soft Magnetic Iron Alloy Sheets According to Examples 1 and 2 and Comparative Examples 1 to 4)

Characteristics of various prepared soft magnetic iron alloy sheets were inspected. Here, the starting material 1 (sample on which the nitrogen penetration heat treatment was not performed) was obtained as the soft magnetic alloy sheet according to Comparative Example 4 for reference of characteristics.

As the magnetic characteristics, the saturation magnetic flux density Bs and the iron loss Pi were measured. Using a vibrating sample magnetometer (manufactured by Riken Denshi Co., Ltd., BHV-525H), the magnetization of the sample (unit: emu) was measured under conditions of magnetic field: 1.6 MA/m and temperature: 20° C. to obtain Bs (unit: T) from the sample volume and the sample mass. With a H coil method using a BH loop analyzer (manufactured by IFG Corporation, IF-BH550) and a vertical yoke single sheet tester, Pi_{-1.0/400} (unit: W/kg) of the sample was measured under conditions of magnetic flux density: 1.0 T, 400 Hz, and temperature: 20° was measured.

As the mechanical characteristics, a tensile strength of a part of the sample was measured using a universal tester.

Using a micro Vickers hardness tester (manufactured by Matsuzawa Co., Ltd., AMT-X7AFS), the Vickers hardness (Hv) of the sample surface was measured (load: 25 gf, holding time: 20 seconds, average of measured values at five points)

In the Vickers hardness test, a commercially available non-directional electromagnetic steel sheet and a Permendur sheet were separately prepared as comparative samples.

The results of the magnetic characteristics and the tensile strength are shown in Table 1.

TABLE 1
Magnetic Characteristics and Mechanical Characteristics
of Examples 1 and 2 Comparative Examples 1 to 4

| | Saturation | Iron Loss | Tensile |
|---|---|---|---|
| | Magnetic Flux | Pi_{-1.0/400} | Strength σ |
| | Density Bs (T) | (W/kg) | (MPa) |
| Example 1 | 2.36 | 45 | Not Measured |
| Example 2 | 2.36 | 45 | 250 |
| Comparative | 2.24 | 50 | Not Measured |
| Example 1 | | | |
| Comparative | 2.20 | 30 | Not Measured |
| Example 2 | | | |
| Comparative | 2.00 | 135 | Not Measured |
| Example 3 | | | |
| Comparative | 2.31 | 35 | 146 |
| Example 4 | | | |

As shown in Table 1, it is verified that, in Examples 1 and 2 according to the present invention, Bs is higher than that of Comparative Examples 1 to 4, which is comparable to Permendur although the Co content is less than half of that of Permendur. Regarding Pi_{-1.00/400}, in Examples 1 and 2, there are substantially no adverse effects of the high N concentration layer, and the iron loss is substantially the same as that of an electromagnetic pure iron sheet.

It is verified that in Example 2 including iron-nitride martensite in the surface layer region, the tensile strength is significantly improved compared to Comparative Example 4 where the nitrogen penetration heat treatment is not performed. In Example 2, the Vickers hardness was 218 Hv. It is verified from the above results that the soft magnetic iron alloy sheet according to the present invention has the same hardness as the commercially available non-directional electromagnetic steel sheet and the Permendur sheet and has the same workability as materials in the related art.

The above-described embodiment and experimental examples have been described to help understanding of the present invention, and the present invention is not limited to the described specific configurations. For example, a part of the configuration of the embodiment can be replaced with a configuration of a common technical knowledge of a person skilled in the art. A configuration of a common technical knowledge of a person skilled in the art may be added to the configuration of the embodiment. That is, in the present invention, for a part of the configurations of the embodiment or the experimental example in the present specification, deletions, replacements with other configurations, and addition of other configurations can be made within a range not departing from the technical idea of the present invention.

1. A soft magnetic iron alloy sheet comprising, as a chemical composition,
0 at % or more and 30 at % or less of cobalt, 0.1 at % or more and 11 at % or less of nitrogen, 0 at % or more and 1.2 at % or less of vanadium, and a remainder consisting of iron and impurities, wherein
in a thickness direction of the soft magnetic iron alloy sheet, a surface layer region having an average nitrogen concentration of 1 at % or more and 15 at % or less and an internal region having a lower average nitrogen concentration than the surface layer region are provided, and
in the surface layer region, a thickness is 1% or more and 30% or less from both main surfaces of the soft magnetic iron alloy sheet and iron-nitride martensite having a tetragonal structure is formed.

2. The soft magnetic iron alloy sheet according to claim 1, wherein
the average nitrogen concentration of the surface layer region is higher than the average nitrogen concentration of the internal region by 0.5 at % or more.

3. The soft magnetic iron alloy sheet according to claim 2, wherein
in the internal region, ferrite having a cubic structure is a primary phase.

4. The soft magnetic iron alloy sheet according to claim 2, wherein
the average nitrogen concentration of the internal region is less than 1 at %.

5. The soft magnetic iron alloy sheet according to claim 1, wherein
a saturation magnetic flux density is 2.3 T or more, and
an iron loss under conditions of a magnetic flux density of 1.0 T and 400 Hz is less than 50 W/kg.

6. A method of manufacturing the soft magnetic iron alloy sheet according to claim 1, the method comprising:
a starting material preparation step of preparing a starting material having a thickness of 0.01 mm or more and 1 mm or less that is formed of a soft magnetic material including iron as a main component and including 30 at % or less of cobalt;
a nitrogen penetration heat treatment step of heating and quenching the starting material in a predetermined ammonia gas atmosphere to cause 1 at % or more and 15 at % or less of nitrogen to penetrate and diffuse into a surface layer region of the starting material; and
a subzero treatment step of cooling the starting material having undergone the nitrogen penetration heat treatment step to 0° C. or lower, wherein
the nitrogen penetration heat treatment step includes a nitrogen penetration process of heating the starting material while controlling a nitriding potential to a predetermined range in an atmosphere and a cooling process of rapidly cooling the starting material to lower than 100° C. at a cooling rate of 100° C./s or faster at a cooling rate while controlling the nitriding potential to a predetermined range in an atmosphere.

7. The method of manufacturing the soft magnetic iron alloy sheet according to claim 6, wherein
the nitriding potential K_{N} is defined as “K_{N}=P_{NH3}/P_{H2}^{3/2}” from an ammonia gas partial pressure P_{NH3} and a hydrogen gas partial pressure P_{H2} in the ammonia gas atmosphere, and is controlled to satisfy “0.001 atm^{-1/2}≤K_{N}≤10 atm^{-1/2}”.

8. The soft magnetic iron alloy sheet according to claim 3, wherein
the average nitrogen concentration of the internal region is less than 1 at %.

9. The soft magnetic iron alloy sheet according to claim 2, wherein
a saturation magnetic flux density is 2.3 T or more, and
an iron loss under conditions of a magnetic flux density of 1.0 T and 400 Hz is less than 50 W/kg.

10. The soft magnetic iron alloy sheet according to claim 3, wherein
a saturation magnetic flux density is 2.3 T or more, and
an iron loss under conditions of a magnetic flux density of 1.0 T and 400 Hz is less than 50 W/kg.

11. The soft magnetic iron alloy sheet according to claim 4, wherein
a saturation magnetic flux density is 2.3 T or more, and
an iron loss under conditions of a magnetic flux density of 1.0 T and 400 Hz is less than 50 W/kg.

12. The soft magnetic iron alloy sheet according to claim 8, wherein
a saturation magnetic flux density is 2.3 T or more, and
an iron loss under conditions of a magnetic flux density of 1.0 T and 400 Hz is less than 50 W/kg.
